(19) United States
(12) Patent Application Publication
(10) Pub. No.: US 2011/0291880 A1
(43) Pub. Date: Dec. 1, 2011

(54) APPARATUS AND METHOD FOR COLLECTING NAVIGATION DATA

(75) Inventor: Shi-Xian YANG, Tainan County (TW)

(73) Assignee: SKYTRAQ TECHNOLOGY, INC., Hsinchu City (TW)

(21) Appl. No.: 12/791,001

(22) Filed: Jun. 1, 2010

(51) Int. Cl. G01S 19/38

(52) U.S. Cl. 342/357.21

(57) ABSTRACT

An apparatus and a method for collecting navigation data are disclosed, where the apparatus includes a correlator, a first buffer, a first calculating unit and a management unit. The correlator can generate a plurality of power bits based on navigation data of a satellite. The first buffer can store a sequence of power bits from the correlator before bit synchronization is completed. The first calculating unit can generate at least one first data bit of a subframe based on the sequence of power bits. The management unit can integrate the at least one first data bit with other data bits of the subframe, so as to constitute the subframe completely.

### BACKGROUND

1. Technical Field

The present disclosure relates to Global Navigation Satellite Systems (GNSS), and more particularly, apparatus and methods for collecting navigation data.

2. Description of Related Art

Global Navigation Satellite Systems (GNSS) is the standard generic term for satellite navigation systems that provide autonomous geo-spatial positioning with global coverage. GNSS allows small electronic receivers to determine their location (longitude, latitude, and altitude) to within a few meters using time signals transmitted along a line-of-sight by radio from satellites. Time to first fix (TTFF) is a specification detailing the time required for a receiver to acquire satellite signals and navigation data, and calculate a position solution (called a fix).

The receiver must search for all possible satellites. After acquiring a satellite signal, the receiver can begin to obtain approximate information on all the other satellites, called almanac. In addition, each satellite broadcasts its own detailed orbital information, called ephemeris. The navigation data of a satellite includes ephemeris and almanac that are transmitted in frames, where each frame consists of five subframes. Of these five subframes, the essential satellite ephemeris and clock parameters are transmitted in the subframe 1, the subframe 2 and the subframe 3, and the almanac is transmitted in the subframe 4 and the subframe 5. Each subframe requires 6 seconds to transmit. Accordingly, to transmit one frame, 30 seconds are required. In other words, the information in the subframes 1-3 is repeated once per 30 seconds. It is necessary to collect the subframes 1-3 so as to obtain a complete ephemeris of the satellite.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

According to one embodiment of the present invention, an apparatus for collecting navigation data includes a correlator, a first buffer, a first calculating unit and a management unit. The correlator can generate a plurality of power bits based on the navigation data of a satellite. The first buffer can store a sequence of power bits from the correlator before bit synchronization is completed. The first calculating unit can generate at least one first data bit of a subframe based on the sequence of power bits. The management unit can integrate the at least one first data bit with other data bits of the subframe, so as to constitute the subframe completely.

According to another embodiment of the present invention, a method for collecting navigation data includes steps as follows. First, a plurality of power bits based on the navigation data of a satellite is generated. Then, a sequence of power bits of the plurality of power bits is stored before bit synchronization is completed. Then, at least one first data bit of a subframe based on the sequence of power bits is generated. Then, the at least one first data bit is integrated with other data bits of the subframe, so as to constitute the subframe completely.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic drawing of baseband architecture of a GNSS-enabled receiver according to one or more embodiments of the present invention;

FIG. 2 is block diagram of an apparatus for collecting navigation data according to one or more embodiments of the present invention; and

FIG. 3 is an illustration showing data structure of a frame of navigation data according to one or more embodiments of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are, no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Global Navigation Satellite System (GNSS) may include the Global Positioning System (GPS), Global Navigation Satellite System (GLONASS), GALILEO, COMPASS Navigation Satellite System (CNSS) and others. The following disclosure uses GPS as an illustrative system, and those skilled in the art will be able to practice the application in conjunction with other satellite systems.

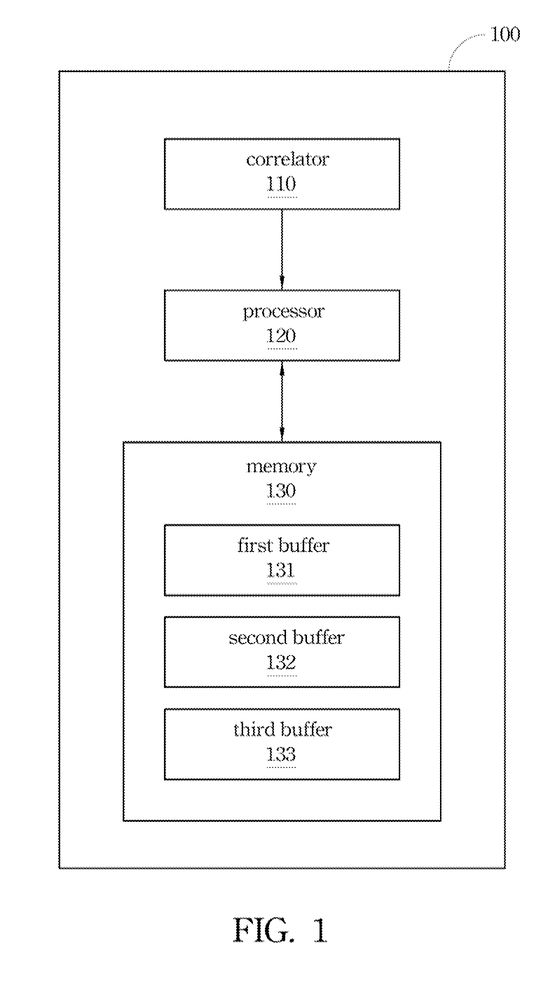

With reference to FIG. 1, a GNSS-enabled receiver 100 in accordance with one or more embodiments of the present invention includes a correlator 110, a processor 120, and a memory 130. The processor 120 is connected to the correlator 110 and the memory 130.

The GNSS-enabled receiver 100 may be a GPS receiver, a GLONASS receiver, a GALILEO receiver, a COMPASS receiver, or any combination thereof, and may be integrated into a personal digital assistant (PDA), a PDA phone, a PDA navigation device, a Personal Navigation Devices (PND), a Portable Navigation Device, a Personal Navigation Assistant (PNA), a pedestrian navigation device, a portable phone, a smart phone, navigation phones, a handheld navigation devices, a GNSS tracker, a GNSS data logger, a Geotagging devices, a GNSS-enabled location finder, a GNSS-enabled position finder, a GNSS-enabled cycle computer, a GNSS-enabled personal trainer, a GNSS-enabled range finders, a dog tracking devices, a vehicle navigation devices, a vehicle tracker, a marine navigation devices, a aviation navigation devices, a surveying devices, a Mobile Internet Device (MID), an Ultra-Mobile PC (UMPC), a GNSS speed alarm, Geocaching devices, or some other GNSS-enabled devices.

In use, the GNSS-enabled receiver 100 receives satellite signals from different satellites. For example, the GNSS-enabled receiver has a GPS engine, RAM, ROM, a temperature-compensated crystal oscillator (TCXO), and a real-time clock (RTC).

The processor 120 has a positioning procedure, a data bit management procedure, and a detection and monitor procedure. The processor 120 may be a central processing unit (CPU), a microprocessor control unit (MCU), a microprocessor, a micro-controller, a microprocessor unit (MPU), a digital signal processor (DSP) or the like.

The memory 130 stores a plurality of 1 millisecond (ms) power bit from the correlator 110 and may have a first buffer 131 storing assistant 1 ms power bit, a second buffer 132 storing assistant data bit, and a third buffer 133 storing valid data bit.

The memory 130 may be a non-volatile memory, a random access memory (RAM), a flash memory, a NAND flash, a PC's disk drive storage, a PC's removable storage, a writable storage or any combination thereof.

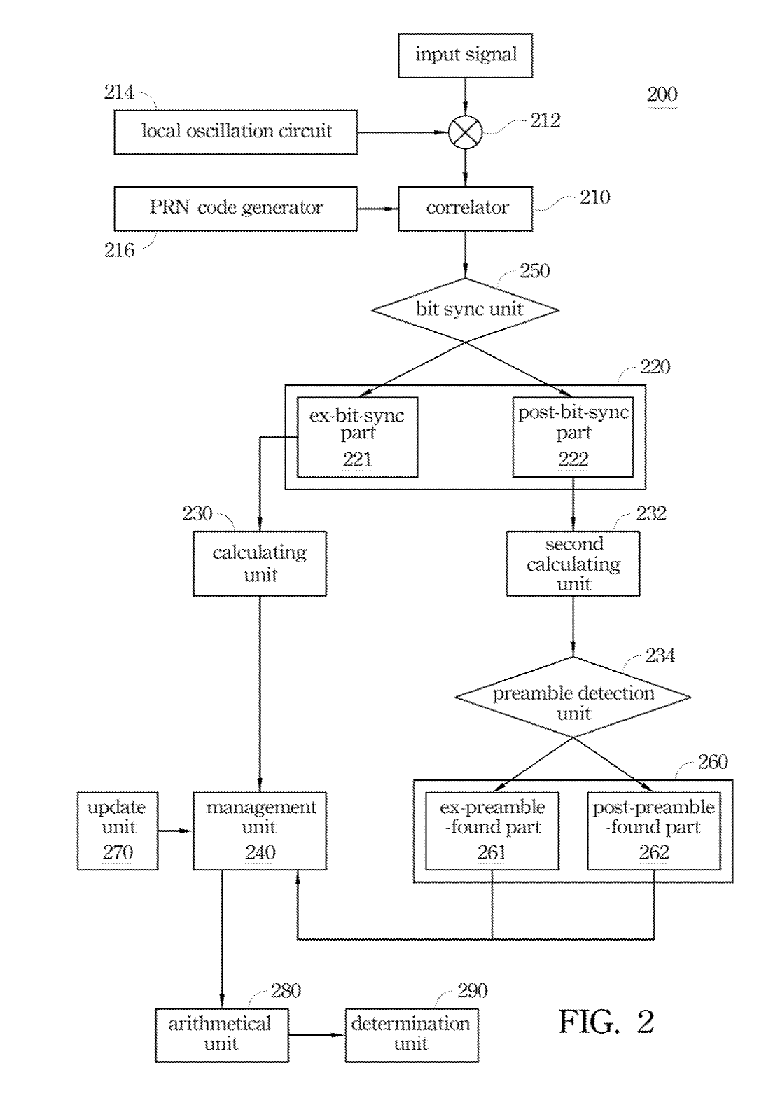

For a more complete understanding of how to collect ephemeris, please refer to FIG. 2. As shown in FIG. 2, the apparatus 200 for collecting navigation data can be easily applied to the GNSS-enabled receiver 100 and may be applicable or readily adaptable to various technologies. For example, the apparatus 200 can be configured in a host-based GPS receiver, a software based GPS receiver or the like. The navigation data may include ephemeris and/or almanac.

The apparatus 200 includes a correlator 210, a first buffer 220, a first calculating unit 230 and a management unit 240. In one embodiment, the correlator 210 is essentially the same as the correlator 110, the first buffer 220 is essentially the same as the first buffer 131, and the first calculating unit 230 with the management unit 240 are integrated into the processor 120.

In global navigation satellite systems, each satellite broadcasts navigation data repeatedly, where the navigation data includes ephemeris essentially consisting of subframes 1-3. In the apparatus 200, the correlator 210 can generate a plurality of power bits based on the navigation data of the satellite. In practice, the correlator 210 correlates the navigation data (e.g. input GPS signal) with a C/A code of a local oscillation circuit 214 through a mixer 212 for in-phase operation to generate one power value (i.e. one power bit) every 1 millisecond. In FIG. 2, local oscillation circuit 214 is electrically coupled with the mixer 212, and the mixer 212 is electrically coupled with the correlator 210. Moreover, a PRN code generator 216 is electrically coupled with the correlator 210. In use, the PRN code generator 216 produces the local PRN code, and the correlator 210 performs correlation measurements to determine the correlation between the local PRN code and the received signal.

The first buffer 220 can store a sequence of power bits as aforesaid assistant power bits from the correlator 210 before bit synchronization is completed. The first calculating unit 230 can generate at least one first data bit of a subframe based on the sequence of power bits stored in the first buffer 220; specifically, one data bit consists of twenty power bits, so that the first calculating unit 230 can sum every twenty power bits to generate one first data bits. Then, the management unit 240 can integrate the at least one first data bit with other data bits of the subframe, so as to constitute the subframe completely.

As to aforesaid bit synchronization, the apparatus 200 may include a bit sync unit 250. In one embodiment, the bit sync unit 250 is integrated into the processor 120. The bit sync unit 250 can determine an edge of a data bit based on the plurality of power bits, so as to complete the bit synchronization.

In practice, one data bit consists of twenty power bits. In general, the power bits of a data bit are positive value if the data bit is logical one; contrarily, the power bits of a data bit are negative value if the data bit is logical zero. If the difference between two adjacent power bits is relatively small, the two adjacent power bits may be in the same data bit; contrarily, if the difference between two adjacent power bits is relatively large, the two adjacent power bits are in the two different data bit respectively, so that one edge of the data bit is found.

For systematically classifying the power bits, the first buffer 220 has an ex-bit-sync part 221 and a post-bit-sync part 222. The ex-bit-sync part 221 can store the sequence of power bits from the correlator 210 before the bit synchronization is completed; comparatively, the post-bit-sync part 222 can store the other sequence of power bits from the correlator 210 when and after the bit synchronization is completed. In the alternative embodiment, the first buffer 220 may be not divided into two parts 221 and 222. Those with ordinary skill in the art may design the first buffer 220 depending on the desired application.

Furthermore, the apparatus 200 may include a second calculating unit 232 and a second buffer 260. In one embodiment, the second buffer 260 is essentially the same as the second buffer 132, and the second calculating unit 232 is integrated into the processor 120.

After the bit synchronization is completed, the second calculating unit 232 can generate second data bits based on the other sequence of power bits stored in post-bit-sync part 222; specifically, the second calculating unit 232 can sum every twenty power bits to generate a second data bits. The second buffer 260 can store one or more of the second data bits as aforesaid assistant data bits before a preamble of a next subframe is found. Moreover, the management unit 240 can integrate aforesaid at least one first data bit, aforesaid one or more of the second data bits with the other data bits of the subframe that are repetitively transmitted at the next time, so as to constitute the subframe completely. Thus, the period of collecting a complete ephemeris can be reduced, so that the TTFF can be shortened.

Moreover, the apparatus 200 may include a preamble detection unit 234. In one embodiment, the preamble detection unit 234 is integrated into the processor 120. In use, the preamble detection unit 234 can search for a preamble of each subframe, wherein each preamble may consist of the first eight data bits of the first word of the subframe that are “1”, “0”, “0”, “0”, “1”, “0”, “1” and “1” in order. Alternatively, each preamble may be “0”, “1”, “1”, “1”, “0”, “1”, “0” and “0” in order when phase reversal occurs in the local oscillation circuit 214.

For systematically classifying the data bits, the second buffer 260 has an ex-preamble-found part 261 and a post-preamble-found part 262. The ex-preamble-found part 261 can store said one or more of the second data bits before the preamble of the next subframe is found; comparatively, the post-preamble-found part can store the other of the second data bits when and after the preamble of the next subframe is found. In the alternative embodiment, the second buffer 260 may be not divided into two parts 261 and 262. Those with ordinary skill in the art may design the second buffer 260 depending on the desired application.

In general, ephemeris of one satellite is updated per two hours. Therefore, the apparatus 200 may include an update unit 270. In one embodiment, the update unit 270 is integrated into the processor 120. In use, the update unit 270 can check whether the update occurs in the navigation data. For example, the update unit 270 counts a time interval of two hours between two successive updates to determine a time point that the next update will occur. Alternatively, the update unit 270 checks IOD (Issue of Data) information of subframes to determine whether an update has occurred.

When the update does not occur, the management unit 240 integrate aforesaid at least one first data bit in the first buffer 220, aforesaid one or more of the second data bits in the second buffer 260 with the other data bits of the subframe that are repetitively transmitted at the next time, so as to constitute the subframe completely.

Whenever the update occurs, the management unit 240 may abandon the aforesaid at least one first data bit in the first buffer 220 and aforesaid one or more of the second data bits in the second buffer 260. Alternatively, even though the update occurs, the management unit 240 may still integrate aforesaid at least one first data bit in the first buffer 220, aforesaid one or more of the second data bits in the second buffer 260 with the other data bits of the subframe that are updated, so as to constitute an approximate subframe.

In practice, the processor 120 utilizes the complete subframes 1-3 to calculate a position solution. Alternatively, the processor 120 may utilize the subframes 1-3, in which one subframe is aforesaid approximate subframe, to calculate an approximate position solution that is relatively inaccurate but is very close to the position solution.

In general, one subframe consists of ten words, in which each word consists of thirty data bits. The local oscillating circuit may sporadically cause phase reversal when the input GPS signal is weak or unstable, and more particularly, an incidence of the phase reversal is raised when the apparatus 200 is struck. When the phase reversal occurs, the sign of power bits are changed from a plus to a minus or changed from the minus to the plus. Moreover, the processor 120 can execute a parity check for words, wherein one or more words may be not passed through the parity check due to the phase reversal. When one word is not passed through the parity check, all data bits of the word are abandoned in conventional art.

For saving the word that is not passed through the parity check, please refer to FIG. 2. The apparatus 200 may include an arithmetical unit 280 and a determination unit 290. In one embodiment, the arithmetical unit 280 and the determination unit 290 are integrated into the processor 120.

In use, the arithmetical unit 280 can determine whether the phase reversal of the local oscillating circuit occurs and then reverse the sign of power bits during the phase reversal occurs. The same subframe is repeated once per 30 seconds. Therefore, the arithmetical unit 280 can calculate two or more difference between the same two adjacent data bits of the same repeated subframes to determine whether the phase reversal occurs. For example, the arithmetical unit 280 can calculate a first difference between two adjacent data bits at the first time; then, arithmetical unit 280 can calculate a second difference between the same adjacent data bits at the second time; then, arithmetical unit 280 can calculate a third difference between the same adjacent data bits at the third time. If the first difference is equal to the second difference, but the second difference is not equal to the third difference, the phase reversal occurs at the third time.

Then, the arithmetical unit 280 can generate a correction value by summing a predetermined amount of power bits at the same position of the same data bit of the same words of the same repeated subframes according to the navigation data when at least one of the words is not passed through a parity check. In this way, the arithmetical unit 280 can provide the sum of the correction values corresponding to all of the power bits of the same data bit. The determination unit 290 can determine each of the data bits at the same bit position is logical one or zero according as the sum of the correction values corresponding to said each of the data bits is positive or negative value. If the sum of the correction values is positive value, the corresponding data bit is logical one. If the sum of the correction values is negative value, the corresponding data bit is logical zero.

In apparatus, the first calculating unit 230, the second calculating unit 232, the preamble detection unit 234, the management unit 240, the bit sync unit 250, the update unit 270, the arithmetical unit 280 and the determination unit 290 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In another aspect, a method for collecting navigation data according to one or more embodiments is disclosed herein. The method may be implemented in a device, such as foresaid GNSS-enabled receiver 100 or the apparatus 200. Alternatively of additionally, the method may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The method for collecting navigation data includes steps as follows. (1) A plurality of power bits based on navigation data of a satellite is generated. (2) A sequence of power bits of the plurality of power bits is stored before bit synchronization is completed. (3) At least one first data bit of a subframe based on the sequence of power bits is generated. (4) The at least one first data bit is integrated with other data bits of the subframe, so as to constitute the subframe completely.

In this method, an edge of a data bit based on the plurality of power bits is determined, so as to complete the bit synchronization.

Then, the other sequences of power bits of the plurality of power bits are stored when and after the bit synchronization is completed. Then, second data bits based on the other sequence of power bits are generated. Then, one or more of the second data bits are generated before a preamble of a next subframe is found. Then, one or more of the second data bits are stored before a preamble of a next subframe is found.

Furthermore, the aforesaid step (4) is to integrate the at least one first data bit, the one or more of the second data bits with the other data bits of the subframe.

Additionally or alternatively, whether an update occurs in the navigation data is checked. When the update does not occur, the at least one first data bit, the one or more of the second data bits are integrated with the other data bits of the subframe.

Moreover, whether a phase reversal occurs is determined. Then, a sign of the power bits is reversed when the phase reversal occurs, and then a correction value is generated by summing a predetermined amount of the power bits at the same position of the same data bits of the same words of the same repeated subframes according to the navigation data when at least one of the words is not passed through a parity check, so as to provide the sum of the correction values corresponding to all of the power bits of the same data bit. Then, each of the data bits at the same bit position is logical one or zero is determined according as the sum of the correction values corresponding to said each of the data bits is positive or negative value.

It should be noted that those implements to perform the steps in the method for collecting navigation data are disclosed in above embodiments and, thus, are not repeated herein.

In view of above, the data bit management procedure includes steps as follows. (a) A plurality of 1 ms power bits continuously generated from the correlator are obtained and stored in the first buffer. (b) Whether a bit-sync is completed is examined by finding an edge of a data bit, wherein if the edge of data bit does not be found, the plurality of power bits are stored in ex-bit-sync part of the first buffer; on the contrary, if the edge of data bit does be found, the plurality of power bits behind the edge of data bit are stored in post-bit-sync part of the first buffer. (c) Every 20 power bits of post-bit-sync part of the first buffer are summed to generate a data bit, and then the data bit is moved in the second buffer. (d) Whether a GPS preamble is found is examined by analyzing data bits, wherein if the preamble does not be found, the data bits are stored in the ex-preamble-found part of the second buffer; on the contrary, if the preamble does be found, the data bits of the preamble and behind the preamble are stored in the post-preamble-found part of the second buffer. (e) The power bits of ex-bit-sync part of the first buffer, the data bits of the ex-preamble-found part of the second buffer, and data bits of post-preamble-found part of second buffer are transmitted to the processor. (f) All power bits and data bits are integrated by summing every 20 power bits to generate an assistance data bit, summing every 30 data bits to generate a word according to the preamble, and summing every 10 words to generate a subframe according to the preamble, and the subframes 1-3 are stored in the memory.

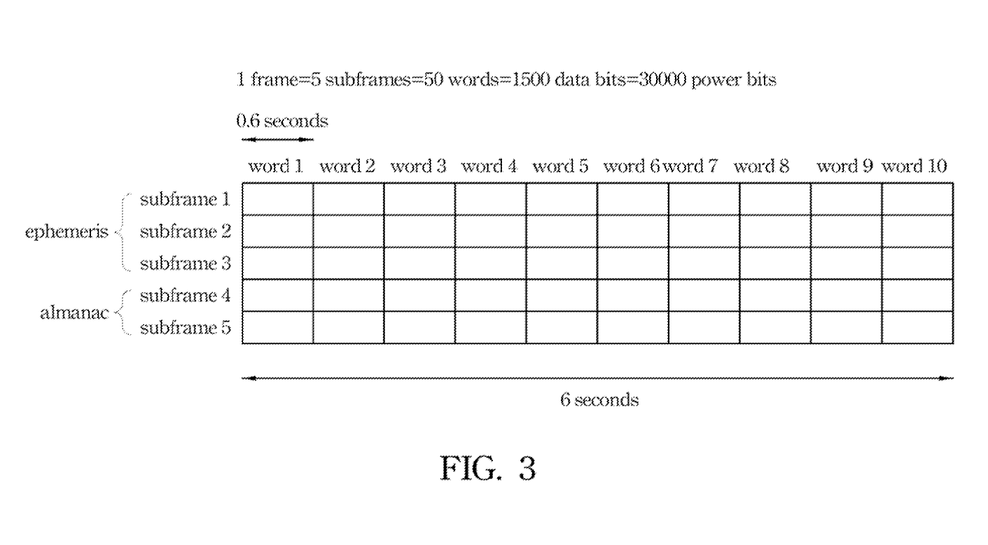

With further reference to FIG. 3, an embodiment can illustrate how the data bit management procedure helps to shorten TTFF. Subframes 1-3 are needed for computing a position and receiving a subframe takes 6 seconds in strong signal condition, so it takes at least 18 seconds to complete receiving subframe 1-3. However, a satellite broadcasts ephemeris that includes subframe 1 to subframe 3 and repeat them again and again. When preamble of subframe 4 is the first found preamble after GNSS-enabled receiver turned on, it takes 30 seconds to complete receiving subframe 4-5 and 1-3. With the help of the data bit management procedure, data bits before preamble of subframe 4 can be stored and integrated to be used as part of subframe 3, so it take less than 6 seconds to complete receiving subframe 3. The help of the data bit management procedure even greater in weak signal condition because it usually takes longer time to find a bit edge and preamble, so more power bits and data bits are stored and integrated and can be used for computing a position.

It should be noted that the phase reversal is an occasional event. Therefore, the predetermined amount may be not too much, such as three. Those with ordinary skill in the art may choose three or more data bits at the same bit position of the same words of the same subframes depending on the desired application.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An apparatus for collecting navigation data, the apparatus comprising:
a correlator for generating a plurality of power bits based on the navigation data of a satellite;
a first buffer for storing a sequence of power bits from the correlator before bit synchronization is completed;
a first calculating unit for generating at least one first data bit of a subframe based on the sequence of power bits; and
a management unit for integrating the at least one first data bit with other data bits of the subframe.

2. The apparatus of claim 1, further comprising:
a bit sync unit for determining an edge of a data bit based on the plurality of power bits, so as to complete the bit synchronization.

3. The apparatus of claim 1, wherein the first buffer comprises:
an ex-bit-sync part for storing the sequence of power bits before the bit synchronization is completed;
a post-bit-sync part for storing the other sequence of power bits from the correlator when and after the bit synchronization is completed.

4. The apparatus of claim 3, further comprising:
a second calculating unit for generating second data bits based on the other sequence of power bits; and
a second buffer for storing one or more of the second data bits before a preamble of a next subframe is found.

5. The apparatus of claim 4, wherein the management unit for integrating the at least one first data bit, the one or more of the second data bits with the other data bits of the subframe.

6. The apparatus of claim 4, further comprising:
an update unit for checking whether an update occurs in the navigation data, wherein when the update does not occur, the management unit for integrating the at least one first data bit, the one or more of the second data bits with the other data bits of the subframe.

7. The apparatus of claim 6, wherein the update unit counts a time interval of two hours to determine a time point that the update has occurred or checks IOD information of the subframes to determine whether the update has occurred.

8. The apparatus of claim 7, wherein the first buffer comprises:
an ex-preamble-found part for storing said one or more of the second data bits before the preamble of the next subframe is found; and
a post-preamble-found part for storing the other of the second data bits when and after the preamble of the next subframe is found.

9. The apparatus of claim 8, further comprising:
an arithmetical unit for reversing a sign of the power bits during a phase reversal occurs and then generating a correction value by summing a predetermined amount of the power bits at the same position of the same data bits of the same words of the same repeated subframes according to the navigation data when at least one of the words is not passed through a parity check, so as to provide the sum of the correction values corresponding to all of the power bits of the same data bit; and
a determination unit for determining each of the data bits at the same bit position is logical one or zero according as the sum of the correction values corresponding to said each of the data bits is positive or negative value.

10. The apparatus of claim 4, wherein the first buffer comprises:
an ex-preamble-found part for storing said one or more of the second data bits before the preamble of the next subframe is found; and
a post-preamble-found part for storing the other of the second data bits when and after the preamble of the next subframe is found.

11. The apparatus of claim 1, further comprising:
an arithmetical unit for reversing a sign of the power bits during a phase reversal occurs and then generating a correction value by summing a predetermined amount of the power bits at the same position of the same data bits of the same words of the same repeated subframes according to the navigation data when at least one of the words is not passed through a parity check, so as to provide the sum of the correction values corresponding to all of the power bits of the same data bit; and
a determination unit for determining each of the data bits at the same bit position is logical one or zero according as the sum of the correction values corresponding to said each of the data bits is positive or negative value.

12. A method for collecting navigation data, the method comprising:
(a) generating a plurality of power bits based on the navigation data of a satellite;
(b) storing a sequence of power bits of the plurality of power bits before bit synchronization is completed;
(c) generating at least one first data bit of a subframe based on the sequence of power bits; and
(d) integrating the at least one first data bit with other data bits of the subframe.

13. The method of claim 12, further comprising:
determining an edge of a data bit based on the plurality of power bits, so as to complete the bit synchronization.

14. The method of claim 12, further comprising:
storing the other sequence of power bits of the plurality of power bits when and after the bit synchronization is completed;
generating second data bits based on the other sequence of power bits; and
storing one or more of the second data bits before a preamble of a next subframe is found, wherein the step (d) comprises:
integrating the at least one first data bit, the one or more of the second data bits with the other data bits of the subframe.

15. The method of claim 14, wherein the step (d) comprises:
checking whether an update occurs in the navigation data; and
integrating the at least one first data bit, the one or more of the second data bits with the other data bits of the subframe when the update does not occur, wherein the step of check whether the update occurs in the navigation data counts a time interval of two hours to determine a time point that the update has occurred or checks IOD information of the subframes to determine whether the update has occurred.

16. The method of claim 9, further comprising:
determining whether a phase reversal occurs;
reversing a sign of the power bits during the phase reversal occurs, and then generating a correction value by summing a predetermined amount of the power bits at the same position of the same data bits of the same words of the same repeated subframes according to the navigation data when at least one of the words is not passed through a parity check, so as to provide the sum of the correction values corresponding to all of the power bits of the same data bit; and
determining each of the data bits at the same bit position is logical one or zero according as the sum of the correction values corresponding to said each of the data bits is positive or negative value.

17. An apparatus for collecting navigation data, the apparatus comprising:
means for generating a plurality of power bits based on the navigation data of a satellite;
means for determining an edge of a data bit based on the plurality of power bits, so as to complete bit synchronization;
means for storing a sequence of power bits of the plurality of power bits before the bit synchronization is completed;
means for generating at least one first data bit of a subframe based on the sequence of power bits; and
means for integrating the at least one first data bit with other data bits of the subframe.

18. The apparatus of claim 17, further comprising:
means for storing the other sequence of power bits of the plurality of power bits when and after the bit synchronization is completed;
means for generating second data bits based on the other sequence of power bits; and
means for storing one or more of the second data bits before a preamble of a next subframe is found, wherein the integrating means integrates the at least one first data bit, the one or more of the second data bits with the other data bits of the subframe.

19. The apparatus of claim 18, further comprising:
means for checking whether an update occurs in the navigation data, so that the integrating means integrates the at least one first data bit, the one or more of the second data bits with the other data bits of the subframe when the update does not occur, wherein the checking means counts a time interval of two hours to determine a time point that the update has occurred or checks IOD information of the subframes to determine whether the update has occurred.

20. The apparatus of claim 17, further comprising:
means for reversing a sign of the power bits during a phase reversal occurs and then generating a correction value by summing a predetermined amount of the power bits at the same position of the same data bits of the same words of the same repeated subframes according to the navigation data when at least one of the words is not passed through a parity check, so as to provide the sum of the correction values corresponding to all of the power bits of the same data bit; and
means for determining each of the data bits at the same bit position is logical one or zero according as the sum of the correction values corresponding to said each of the data bits is positive or negative value.
